(19) United States
(12) Patent Application Publication
(10) Pub. No.: US 2013/0055549 A1
(43) Pub. Date: Mar. 7, 2013

(54) METHOD OF INSTALLING A CORELESS RIVET, ADAPTED RIVET AND INSTALLATION TOOL

(71) Applicants: Pierre Auriol, Flourens (FR); Jean-Marc Auriol, Flourens (FR)

(72) Inventors: Pierre Auriol, Flourens (FR); Jean-Marc Auriol, Flourens (FR)

(21) Appl. No.: 13/636,134

(22) PCT Filed: Mar. 2, 2012
(86) PCT No.: PCT/FR2012/050441

§ 371 Date: Sep. 20, 2012

(30) Foreign Application Priority Data
Mar. 4, 2011 (FR) 1151768

(51) Int. Cl. B21J 15/02; F16B 19/10; B21J 15/10

(52) U.S. Cl. 29/525.07; 29/243.54; 411/501

(57) ABSTRACT

The invention relates to a method for installing a rivet (R, R′, R″, R2) for the purpose of assembling at least two elements (300, 400) through which a hole passes, in which the rivet (R) is positioned in said hole and is of the type comprising a head (100) coming to rest on the edge of the hole and a tubular or semi-tubular rod (200) of which the free open end (220) is deformed, for the purpose of creating a bearing surface, in which a snap (B, B′) ensures the deformation of said free end (220) by bringing the snap (B, B′) toward the first tool,

remarkable in that it consists of interposing a film (500, 600, 700) of material between the snap (B, B′) and the end to be deformed during installation.

The invention also relates to a corresponding rivet and installation tool.

Applications: rivet installation.

### FIELD OF APPLICATION OF THE INVENTION

This invention relates to the field of attachment by rivet and in particular adaptations enabling a rivet to be installed under the best conditions.

### DESCRIPTION OF THE PRIOR ART

The applicant, seeking to optimize attachments and the mechanical capacities of same, has conducted studies aimed at identifying defects that may optionally be observed once installed.

It is noted that rivets such as those described in documents EP 2131975, EP 0512049, EP 0216405 are capable of having splits called cracks.

These rivets include a head and a tubular or semi-tubular rod of which the open free end is deformed in an outwardly flared manner so as to create a bearing and holding surface opposite that proposed by the conventional countersunk head. The exterior surface of the deformed portion comes into contact, by flaring outwardly, with the surface of the countersink formed at the end of the hole and receiving the rivet and passing through the materials to be assembled.

It is in this deformed portion that said crack occurs.

Such a disadvantage must, insofar as possible, be avoided and all the more so when the rivet installed constitutes a structural attachment.

Another disadvantage observed in the installation of said tubular or semi-tubular rivets lies in the creation of a bending of surface fibers of the deformed portion of the rivet. Indeed, it has been noted, in particular on rivets made of titanium or an equivalent alloy, that the surface fibers coming into contact with tool for installing the portion to be deformed could be subject to bending due to an improper point-specific orientation of the metal fibers during deformation.

The prior art does not solve these defects because either they have not been identified or they are not large enough to weaken the attachment obtained in the context of the chosen application.

However, as explained above, when rivets with a tubular or semi-tubular rod must constitute structural attachments, it becomes especially important to reduce the likelihood that any defects will appear.

### DESCRIPTION OF THE INVENTION

On the basis of this fact, the applicant conducted research aimed at overcoming the aforementioned disadvantages by studying the method of installation and not the rivet. Indeed, a solution might have consisted of the production of a rivet with a more resistant material of which the fibers would not be broken to form a crack or would not be improperly oriented so as to form a bend. Nevertheless, such a choice makes the rivet less deformable and much more expensive to produce.

This research was intended to solve the technical problem of the possible appearance of cracks and bends in the deformed portion of the rivet and has thus led to a method enabling the desired result to be achieved, namely a rivet installed without cracks or bends. This method is capable of being applied both to the tubular or semi-tubular rivets described in the aforementioned documents and to the rivets comprising a semi-tubular portion such as an insert, of which the deployment constitutes the bearing and holding surface positioned opposite that provided by the head.

The installation method of the invention ensures the installation of a rivet for the purpose of assembling at least two elements through which a hole passes, in which the rivet is positioned in said hole. This rivet is of the type comprising a head coming to rest on the edge of the hole and a tubular or semi-tubular rod of which the free open end is deformed, so as to create a bearing surface, or receives a semi-tubular insert of which the end deforms so as to create a bearing surface. Said method includes a first tool called a stake that holds the head in contact with the edge of the hole and a second tool called a snap that ensures the deformation of said free end by bringing the snap toward said first tool.

According to the invention, this method is remarkable in that it consists of interposing a material film between the snap and the end to be deformed.

This feature is especially advantageous in that it makes it possible to install a rivet without the risk of a crack. The applicant has indeed noted that the presence of an interposed material in the transmission of stresses deforming the end makes it possible to better transmit the stresses. This interposed material also makes it possible to avoid micro-welding and therefore has a lubricating effect, enabling said stresses to be better controlled. It prevents in particular the uncontrolled swelling of the rod in the hole. Such a method will enable the rivets to which it is applied to be used as structural attachments.

The suppression of micro-welding prevents gripping of the surfaces in contact and therefore prevents the return of the surface fibers of the portion to be deformed by keeping them substantially parallel to the contact surface provided by the snap.

The prior art includes a method for installing a rivet as described in document U.S. Pat. No. 3,001,279, which proposes lubricating the end of the rivet to be deformed. Nevertheless, the technical problem is not the same. Indeed, even though the method of this document seeks to prevent sticking and gripping during the deformation operation between the solid end and the snap, the invention proposes avoiding the effects of such sticking or gripping for a tubular end, namely the possibility of appearance of cracks and/or bends.

The interposition defined by this first feature does not limit the surface of the sheet or the moment at which it is prepositioned. The method of the invention indicates that during installation/deformation of the rivet, a film is interposed, but not that the film is positioned at that moment.

Thus, for example:

the film to be interposed may be prepositioned on the rivet during production of the rivet before the rivet installation operation, or

the film to be interposed may be prepositioned on the snap before the rivet installation operation,

etc.

According to a particularly advantageous feature, said film is a sheet of material. This sheet is capable of being deformed.

According to another particularly advantageous feature, said material is plastic.

According to a preferred but non-limiting embodiment, this plastic is polypropylene. According to another preferred but non-limiting embodiment, this plastic is polyethylene.

According to another particularly advantageous feature, the film of material consists of a lubricant film.

According to another feature, said lubricant is a dry molybdenum disulfide-type lubricant.

According to another particularly advantageous feature of the invention, said film consists of a painting-type coating.

According to another particularly advantageous feature of the invention, said film is applied on the rivet at least on the surface of the deformable part coming into contact with the snap.

According to another particularly advantageous feature of the invention, said film is applied on the entire surface of the rivet.

According to a particularly advantageous feature of the invention, said rivet is made of a material included in the following list:
pure titanium,
columbium titanium,
titanium alloy,
titanium alpha +beta alloy.

Even though, as explained above, the prior art is more likely to involve a change in material for the production of rivets in order to prevent cracking, the invention is remarkable in that it proposes rivets made of a conventionally used material such as titanium. Thus, for a rivet of the same size and the same material, the implementation of the method of the invention ensures a deformation without cracks or bends.

According to another particularly advantageous feature of the invention, said rivet is of the type comprising a hollow core with a frustoconical profile. These rivets are most capable of having a crack once installed and are therefore most capable of serving as a basis for implementation of the method of the invention. The same applies to those having a countersunk head and receiving the deformed portion in a countersink.

According to another particularly advantageous feature of the invention, said film of material is installed in the hollow core of the end to be deformed so that the snap comes into contact with said sheet during installation.

According to another particularly advantageous feature of the invention, the installation of said rivet is performed in a single operation by a single snap. This choice makes it possible to propose a method that is particularly beneficial in that, not only does it prevent cracks and bends owing to the presence of the inserted sheet of material, but it also eliminates the need to use a second snap and the time required for this use.

The invention also relates to a rivet suitable for such a method that is remarkable in that, when it is produced, its hollow core is equipped with a lining of said interposed material. The preliminary insertion of a lining in each rivet eliminates the technical features necessary for the systematic interpositioning operation proposed by the invention between a rivet of the prior art and a snap of the prior art.

The invention also relates to the installation tool suitable for the method of the invention and remarkable in that it includes a snap receiving a portion of interposed material.

According to another particularly advantageous feature of the invention, the snap includes a surface for contact with the tubular or semi-tubular end adopting two angles of conicity:
a first central cone having an angle of 110°,
a second cone peripheral to the first, having an angle of 140°.

The basic concepts of the invention disclosed above in their most basic form, additional details and features will become clearer in view of the following description and appended drawings, provided by way of a non-limiting example, of several embodiments of a method for installing a rivet, a rivet and an installation tool according to the invention.

### BRIEF DESCRIPTION OF THE DRAWINGS

FIG. 1 is a diagrammatic drawing of a cross-section view of an embodiment of a rivet to which the method of the invention is applied.

FIGS. 2, 3 and 4 are diagrammatic cross-section drawings showing the installation of the rivet of FIG. 1 according to the method of the invention.

FIG. 5 is a diagrammatic drawing of a cross-section view of an embodiment of a rivet according to the invention.

FIG. 6 is a diagrammatic drawing of a cross-section view of another embodiment of a rivet according to the invention.

FIG. 7 is a diagrammatic drawing of a cross-section view of an embodiment of a rivet to which the method of the invention is applied and an embodiment of an installation tool according to the invention.

FIG. 8 is a diagrammatic drawing of another embodiment of a rivet according to the invention.

FIG. 9 is a diagrammatic drawing of another embodiment of a rivet according to the invention.

FIG. 10 is a diagrammatic drawing of an embodiment of a snap of an installation tool according to the invention.

### DESCRIPTION OF PREFERRED EMBODIMENTS

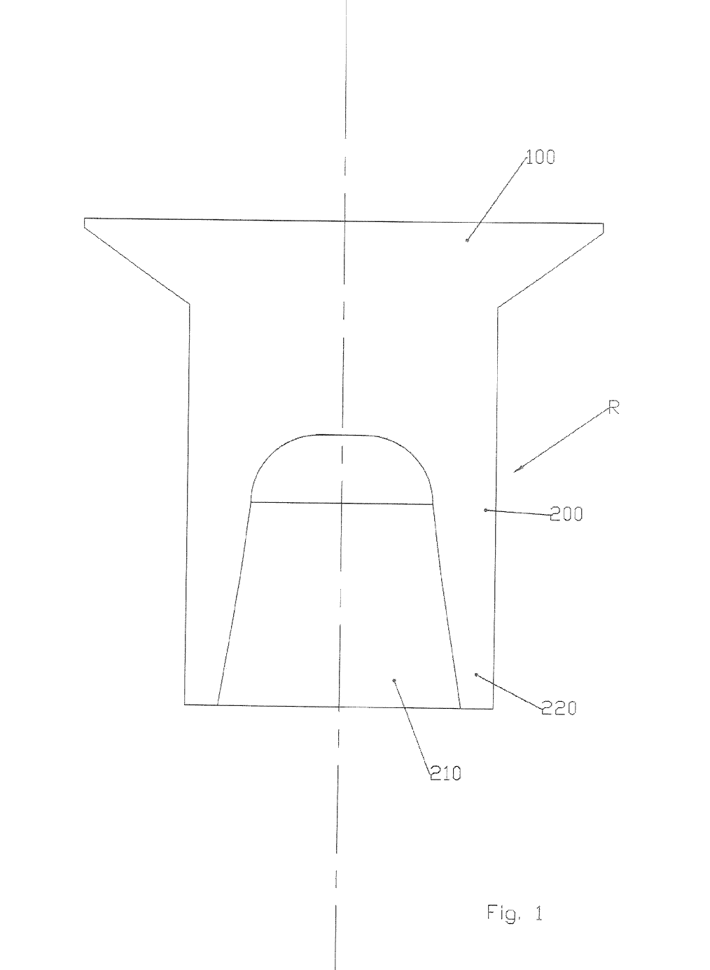

As shown in the drawing of FIG. 1, the method of the invention applies more specifically to rivets of the type shown in the drawing of FIG. 1. This rivet R is of the type comprising a head 100 and a semi-tubular rod 200 comprising a hollow core 210 with a frustoconical profile, of which the free open end 220 is deformed for the purpose of creating a bearing surface.

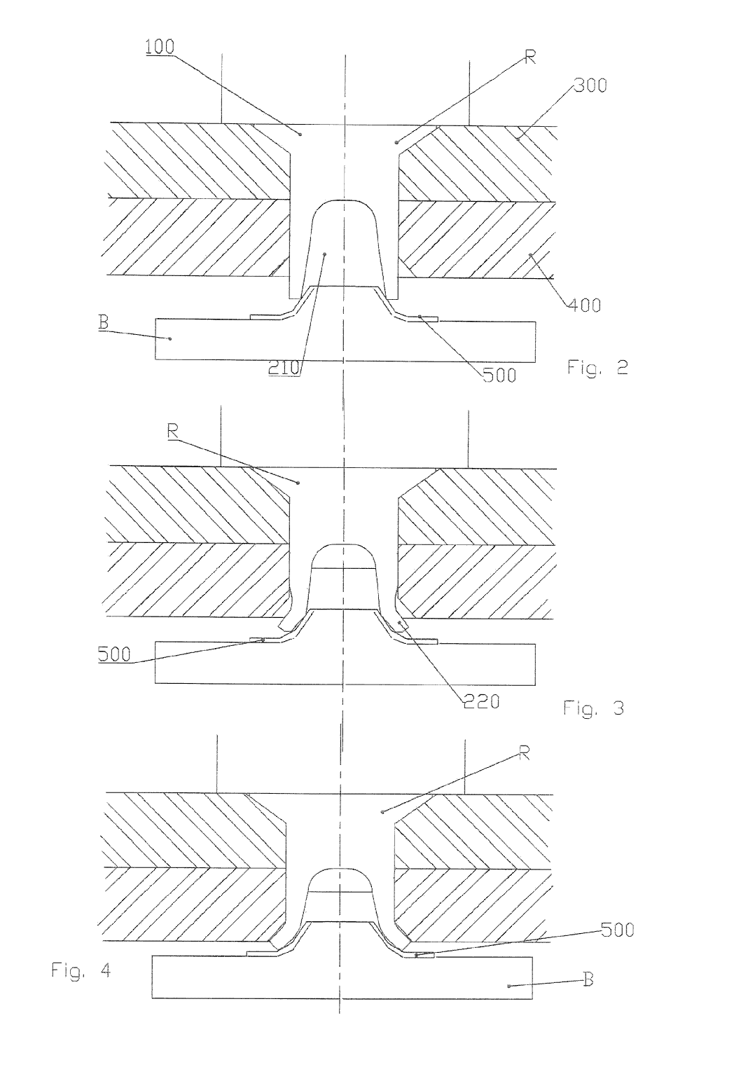

The installation of said rivet R is shown by the drawings of FIGS. 2 to 4, which show an assembly between the panels of material 300 and 400 through which a hole T passes at the two ends of which a countersink has been produced, filled by the volume of the head 100 itself countersunk on one side of the assembly and by the deformation of the free open end 220 of the rod 200 of the rivet R on the other side of the assembly, which deformation is caused by bringing the snap B toward the surface of material 400.

Conventionally, it is at the level of the deformed wall of the end 220 of the rod surrounding the hollow portion 210 that the cracking is most likely to occur.

To avoid this disadvantage, the method of the invention is remarkable in that it consists of interposing a sheet of plastic material 500 between the snap B and the free open end of the rivet R to be deformed.

The interpositioning of this material during deformation prevents the appearance of cracks in the deformed portion.

As shown, said plastic sheet is placed on the snap B so that the latter does not come into direct contact with the rivet. As shown, the installation of said rivet R is performed in a single operation by a single snap B. To do this, the snap has a series of axial cones with different conicities.

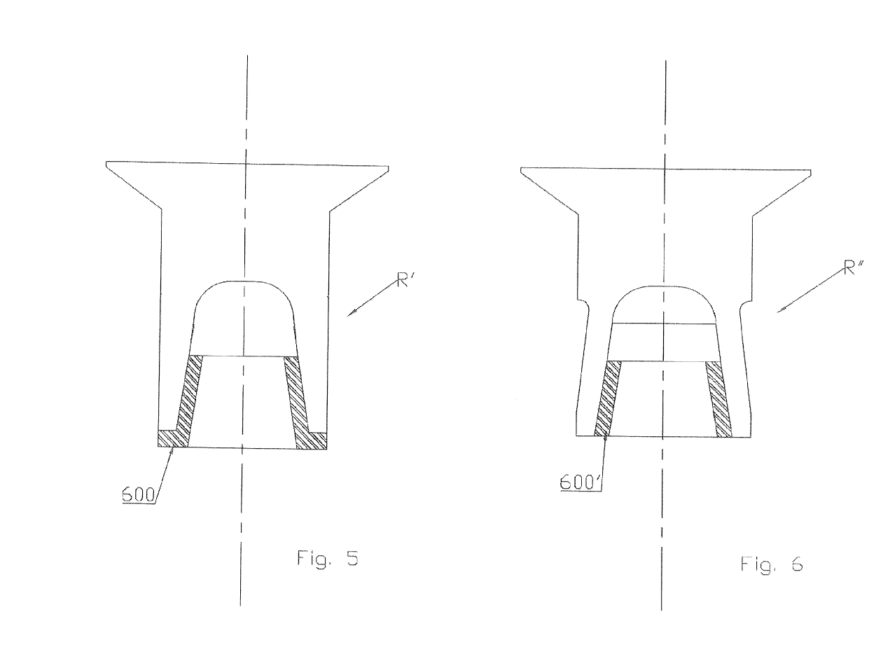

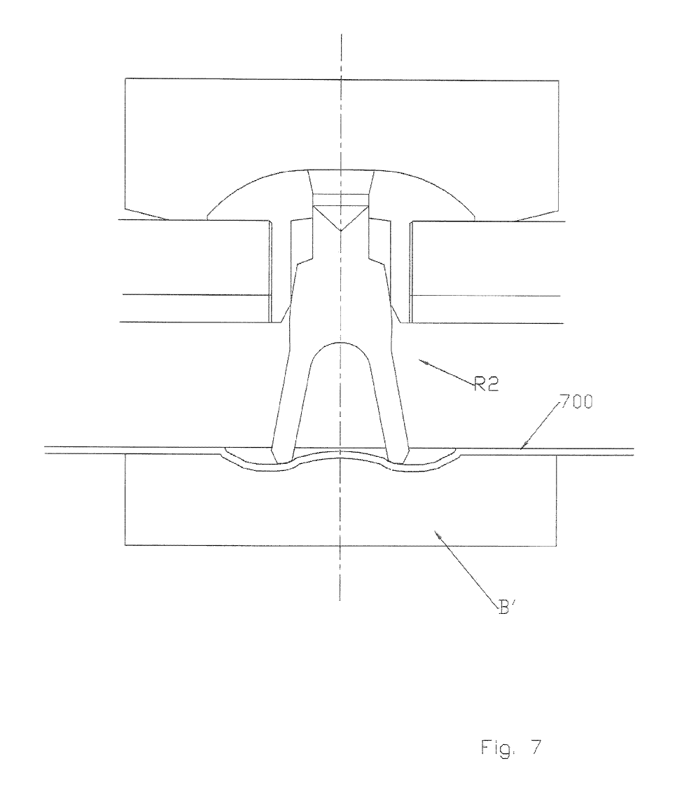

To implement this method without having to systematically provide an operation of interpositioning an independent sheet of material 500 between the rivet and the snap when it is placed just before deformation, the applicant has advantageously imagined rivets enabling the method to be implemented, as illustrated by the drawings of FIGS. 5 and 6.

As shown in the drawing of FIG. 5, the rivet R′ includes, in its hollow core, a lining 600 of plastic material, which lining is intended to perform the function of the above-described interposed sheet so as to prevent the appearance of cracks. This lining 600 also has a collar facilitating its positioning in said hollow core.

In addition to the fact that it is not the same model as that shown in FIG. 5, the rivet R″ shown in the drawing of FIG. 6 includes, in its hollow core, a lining 600′ without a collar. These linings can be provided during manufacture.

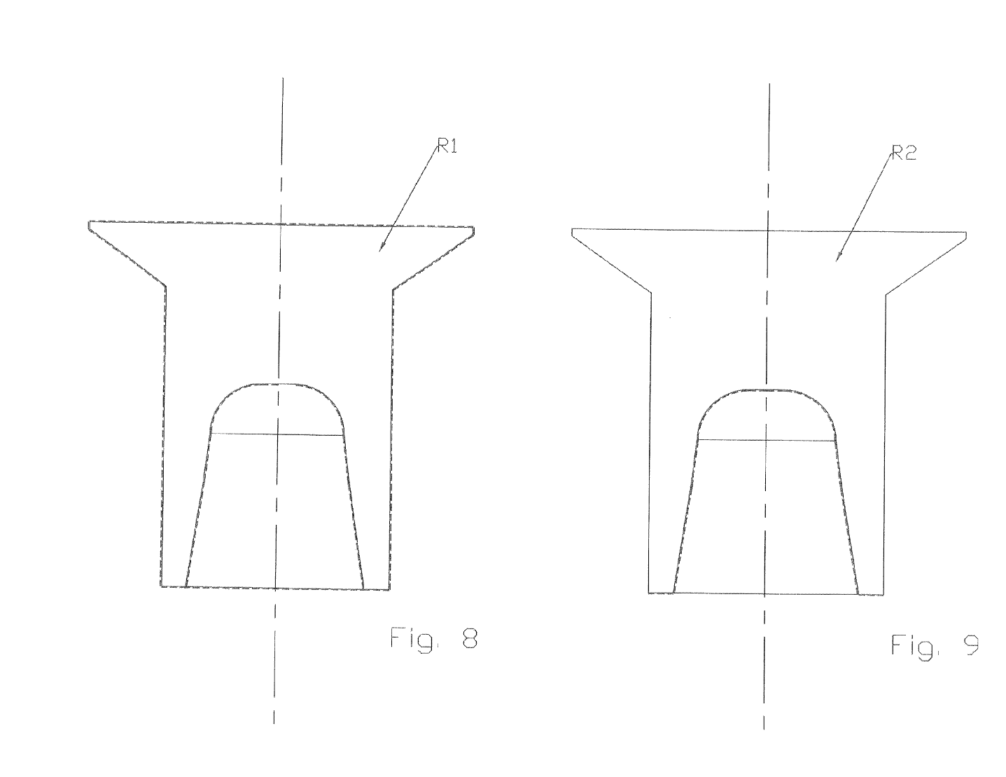

The drawing of FIG. 7 shows a rivet R2 different from those shown above in that it is an insert that will expand to form a bearing surface and not the free end of the rod. This type of rivet is subject to the same disadvantages in that the deformed end of the insert may have a crack. In addition, such a rivet R2 is capable of having its method of installation modified so as to interpose a sheet of material between the snap B′ and the end of the insert to be deformed as shown in the drawing in which the snap B′ receives an interposition sheet 700 according to the invention.

The drawings of FIGS. 8, 9 and 10 show rivets on which a film f is applied.

According to the embodiment shown in the drawing of FIG. 8, said film f consisting of a film of lubricant material or a coating of paint is applied on the entire surface of the rivet R1.

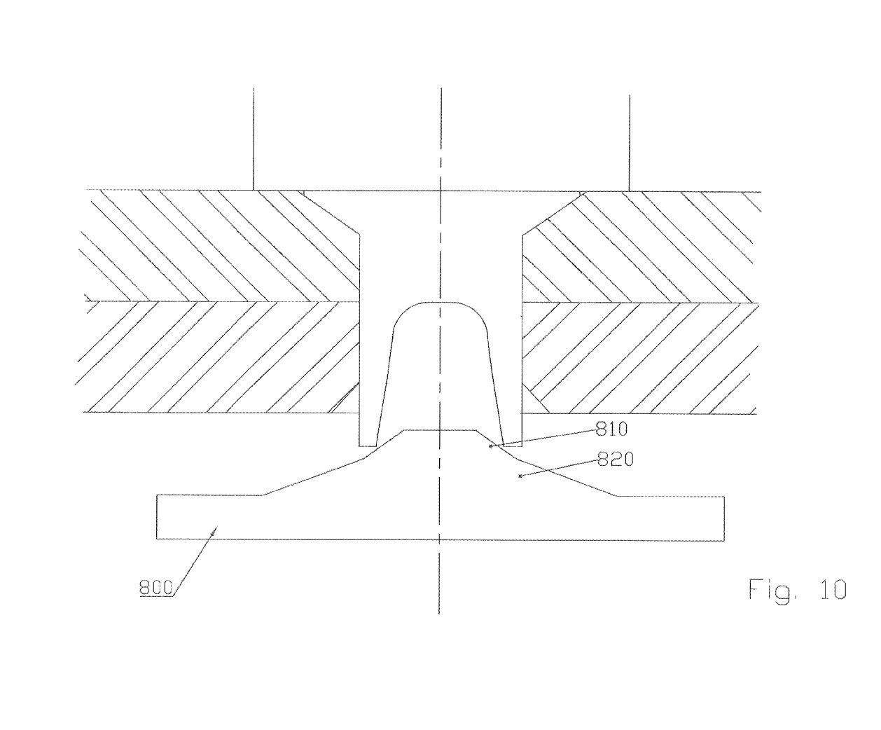

According to the embodiment shown in the drawing of FIG. 9, said film f is applied on the surface of the deformable portion of the rivet R2 coming into contact with the snap B.

To do this, and according to a preferred embodiment, the rivet is subjected to an electrolytic conversion in a sulfuric and oxalic acid medium, then to a molybdenum disulfide spray using a gun.

According to the embodiment shown in the drawing of FIG. 10, the snap 800 includes a surface for contact with the tubular or semi-tubular end adopting two angles of conicity:
a first central cone 810 having an angle of 110°,
a second cone 820 peripheral to the first, having an angle of 140°.

It is understood that the method, the rivet and the installation tool described above and illustrated have been done so for the purpose of disclosure rather than limitation. Of course, various arrangements, modifications and improvements may be made to the example above without going beyond the scope of the invention.

1. Method for installing a rivet for the purpose of assembling two elements through which a hole passes, in which the rivet is positioned in said hole and is of the type comprising a head coming to rest on the edge of the hole and a tubular or semi-tubular rod of which the free open end is deformed, for the purpose of creating a bearing surface, or receives a semi-tubular insert of which the end deforms for the purpose of creating a bearing surface,
said method includes a first tool called a stake that holds the head in contact with the edge of the hole and a second tool called a snap that ensures the deformation of said free end by bringing the snap toward the first tool,
characterized in that it consists of interposing a film of material between the snap and the end to be deformed during installation.

2. Method according to claim 1, characterized in that said film is a sheet of material.

3. Method according to claim 1, characterized in that said material is plastic.

4. Method according to claim 1, characterized in that said film is installed in the hollow core of the end to be deformed so that the snap comes into contact with said sheet during installation.

5. Method according to claim 1, characterized in that the installation of said rivet (R) is performed in a single operation by a single snap.

6. Method according to claim 1, characterized in that the film of material consists of a lubricant film.

7. Method according to claim 1, characterized in that said lubricant is a dry molybdenum disulfide-type lubricant.

8. Method according to claim 1, characterized in that said film consists of a paint-type coating.

9. Method according to claim 1, characterized in that said film is applied to the rivet on the surface of the deformable portion coming into contact with the snap.

10. Method according to claim 1, characterized in that said film is applied on the entire surface of the rivet.

11. Rivet suitable for the method according to claim 1, characterized in that, during its production, its hollow core is equipped with a lining (600, 600′) of said interposed material.

12. Installation tool suitable for the method according to claim 1, characterized in that it includes a snap receiving an interposed material portion.

13. Installation tool suitable for the method according to claim 1, characterized in that the snap includes a surface for contact with the tubular or semi-tubular end adopting two angles of conicity:
a first central cone having an angle of 110°,
a second cone peripheral to the first, having an angle of 140°.
